(19) United States
(12) Patent Application Publication
(10) Pub. No.: US 2019/0228760 A1
(43) Pub. Date: Jul. 25, 2019

(54) INFORMATION PROCESSING SYSTEM, INFORMATION PROCESSING APPARATUS, INFORMATION PROCESSING METHOD, AND RECORDING MEDIUM

(71) Applicants: Kabushiki Kaisha Toshiba, Minato-ku (JP); Toshiba Digital Solutions Corporation, Kawasaki-shi (JP)

(72) Inventors: Yuki KANEKO, Ota (JP); Yasunari TANAKA, Kawasaki-shi (JP); Masahisa SHINOZAKI, Tokorozawa (JP); Hisako YOSHIDA, Kawasaki (JP)

(73) Assignees: Kabushiki Kaisha Toshiba, Minato-ku (JP); Toshiba Digital Solutions Corporation, Kawasaki-shi (JP)

(21) Appl. No.: 16/336,779

(22) PCT Filed: Sep. 13, 2017
(86) PCT No.: PCT/JP2017/033084

§ 371 Date: Mar. 26, 2019

(30) Foreign Application Priority Data
Sep. 29, 2016 (JP) 2016-191015

(51) Int. Cl. G10L 13/04; G06N 20/00; G10L 13/027

(52) U.S. Cl. CPC G10L 13/04; G10L 13/027; G06N 20/00

(57) ABSTRACT

An information processing system according to an embodiment includes a conversationer, a storage, and a system-user conversationer. The conversationer performs conversation with a user by generating a speech. The storage stores conversation information indicating a conversation rule of the speech. The system-user conversationer converts the speech generated by the conversationer into a mode according to the user by using the conversion information stored in the storage.

### TECHNICAL FIELD

Embodiments of the present invention relate generally to an information processing system, an information processing apparatus, an information processing method, and a recording medium.

### BACKGROUND

There is a system that searches for solutions to inquiries from users using information processing technology and presents them to users. However, in the conventional technology, there are cases in which both versatility and diversity cannot be achieved at the same time because the response to the inquiry is uniform or depends on the user.

### CITATION LIST

### Patent Literature

### PTL 1: Japanese Translation of PCT International Application Publication No. 2008-512789

### SUMMARY OF THE INVENTION

### Problems to be Solved by the Invention

It is an object of the present invention to provide an information processing system, an information processing apparatus, an information processing method, and a recording medium that can achieve both versatility and diversity.

### Means for Solving the Problem

An information processing system according to an embodiment includes a conversationer, a storage, and a system-user conversationer. The conversationer performs conversation with a user by generating a speech. The storage stores conversation information indicating a conversation rule of the speech. The system-user conversationer converts the speech generated by the conversationer into a mode according to the user by using the conversion information stored in the storage.

### BRIEF DESCRIPTION OF DRAWINGS

FIG. 1 is a diagram illustrating an overview of an information processing system according to a first embodiment.

FIG. 2 is a diagram illustrating an overview of a filter according to the embodiment.

FIG. 3 is a block diagram illustrating a configuration of an information processing system according to the embodiment.

FIG. 4 is a block diagram illustrating a configuration of a terminal apparatus according to the embodiment.

FIG. 5 is a block diagram illustrating a configuration of a response control apparatus according to the embodiment.

FIG. 6 is a diagram illustrating a data configuration of user information according to the embodiment.

FIG. 7 is a diagram illustrating a data configuration of history information according to the embodiment.

FIG. 8 is a flowchart illustrating a flow of processing by the information processing system according to the embodiment.

FIG. 9 is a first diagram illustrating a presentation example of response by the information processing system according to the embodiment.

FIG. 10 is a second diagram illustrating a presentation example of response by the information processing system according to the embodiment.

FIG. 11 is a diagram illustrating an overview of a filter according to a second embodiment.

FIG. 12 is a block diagram illustrating a configuration of a response control apparatus according to the embodiment.

FIG. 13 is a flowchart illustrating a flow of processing by the information processing system according to the embodiment.

FIG. 14 is a diagram illustrating an overview of a filter according to a third embodiment.

FIG. 15 is a block diagram illustrating a configuration of a response control apparatus according to the embodiment.

FIG. 16 is a flowchart illustrating a flow of processing by the information processing system according to the embodiment.

FIG. 17 is a block diagram illustrating a configuration of a terminal apparatus according to a fourth embodiment.

FIG. 18 is a block diagram illustrating a configuration of a response control apparatus according to the embodiment.

### EMBODIMENTS FOR CARRYING OUT THE INVENTION

Hereinafter, an information processing system, an information processing apparatus, an information processing method, and a program according to the embodiments will be described with reference to the drawings.

### First Embodiment

First, an overview of an information processing system 1 according to the first embodiment will be described.

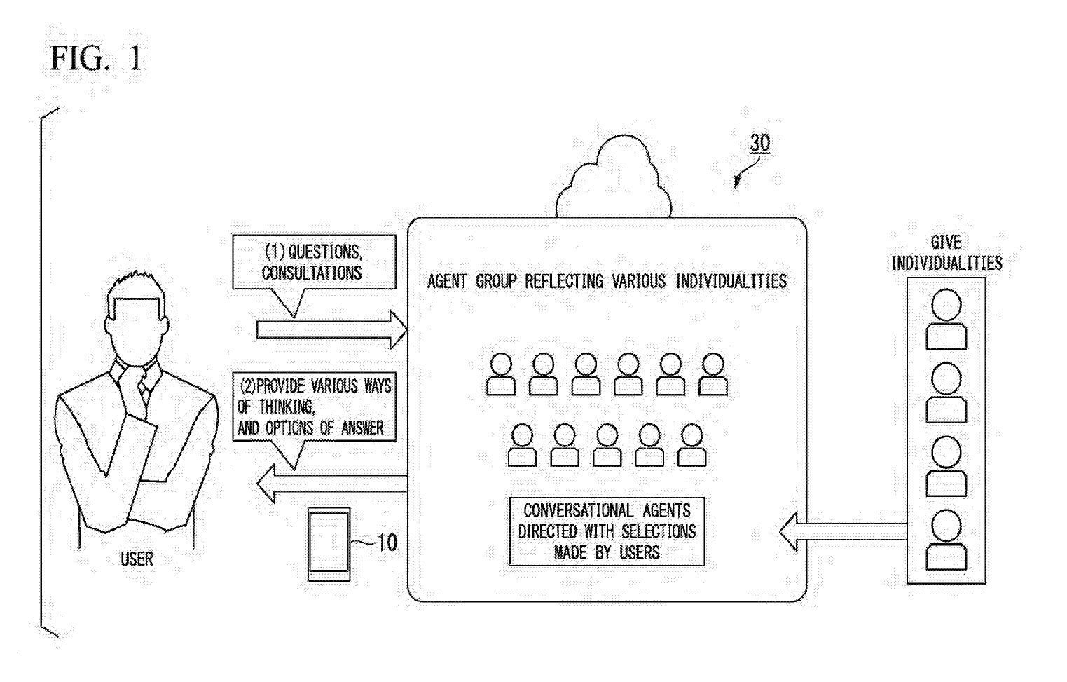

FIG. 1 is a diagram illustrating an overview of the information processing system 1 according to a first embodiment.

As illustrated in FIG. 1, the information processing system 1 is a system that returns speeches such as opinions and options for user's speeches. Hereinafter, speech returned by the information processing system 1 in reply to user's speech is referred to as “response”. Hereinafter, the exchange between user's speech and speech generated by information processing system 1 is referred to as “conversation”. The speech from the user input to the information processing system 1 and the response output from the information processing system 1 are not limited to voice but may be text or the like.

The information processing system 1 has a configuration for generating response. Hereinafter, a unit of a configuration that can independently generate a response is referred to as an “agent”. The information processing system 1 includes a plurality of agents. Each agent has different individualities. Hereinafter, “individuality” is an element that affects the trend of response, the content of response, the expression style of response, and the like. For example, the individualities of each agent are used for the contents of information (for example, training data of machine learning, history information described later, user information, and the like) used for generating response, logical development in generation of response, and algorithm used for generation of response and so on. The individualities of the agent may be made in any way. In this way, since the information processing system 1 presents responses generated by multiple agents with different individualities, the information processing system 1 can present various ideas and options to the user, and can support decisions made by the user.

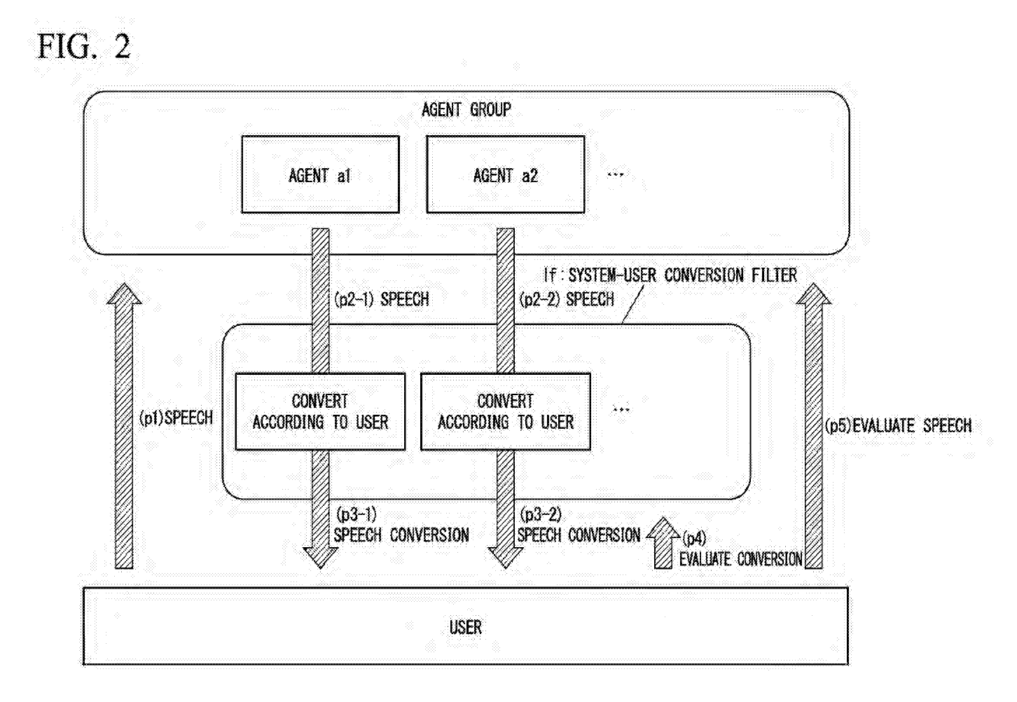

In the present embodiment, the response by each agent is presented to the user via conversion performed by filters. Here, with reference to FIG. 2, an overview of flow of conversation and conversion by filters will be described.

FIG. 2 is a diagram illustrating an overview of a filter according to the present embodiment.

In the conversation according to the present embodiment, first, the user makes a speech such as a question (p1). Next, agents a1, a2, . . . generate responses in reply to user's speech (p2-1, p2-2, . . . ), respectively. The response generated by the agent depends on the user's speech content, not depending on user.

Next, a system-user conversion filter lf converts the responses of the agents a1, a2, . . . according to user and presents the converted responses to the user (p3-1, p3-2, . . . ). In the present embodiment, the system-user conversion filter lf is provided for each user. Next, the user evaluates the response of agents a1, a2, . . . This evaluation is reflected in the conversion processing by system-user conversion filter lf and the generation processing of the response by agents a1, a2, . . . (p4, p5). In this way, the information processing system 1 does not present the responses of the agents a1, a2, . . . as they are, but presents them upon conversion. Therefore, a desirable response according to the users can be presented.

Next, the configuration of the information processing system 1 will be described.

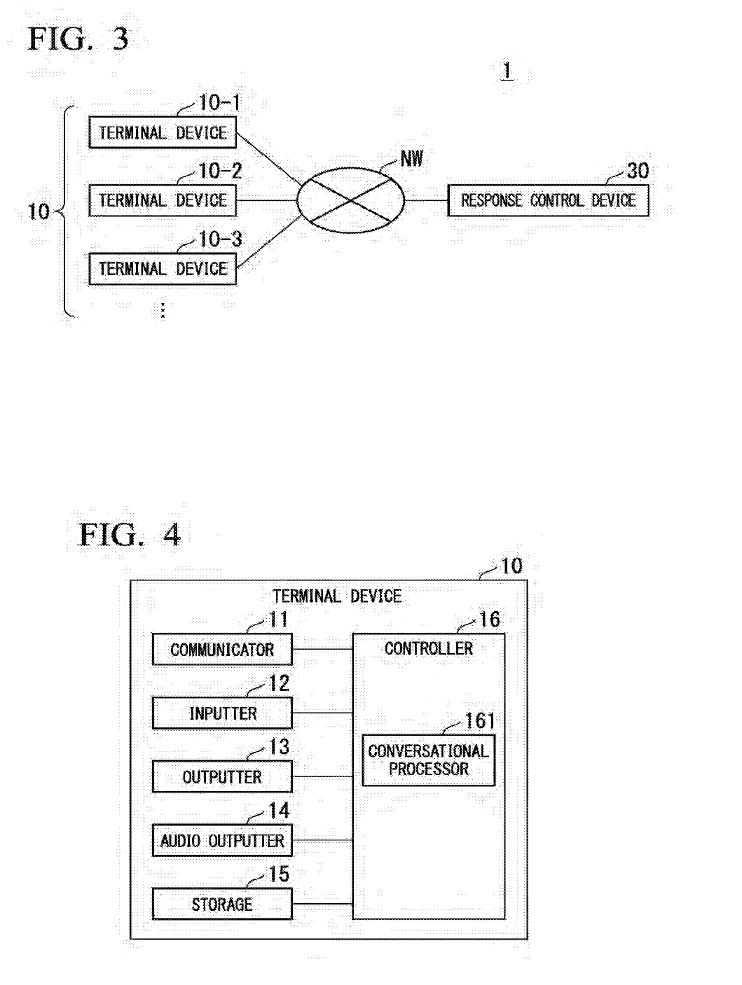

FIG. 3 is a block diagram illustrating a configuration of the information processing system 1 according to the embodiment.

The information, processing system 1 comprises a plurality of terminal apparatuses 10-1, 10-2, . . . and a response control apparatus 30. Hereinafter, the plurality of terminal apparatuses 10-1, 10-2, . . . will be collectively referred to as “terminal apparatus 10”, unless they are distinguished from each other. The terminal apparatus 10 and the response control apparatus 30 are communicably connected via a network NW.

The terminal apparatus 10 is an electronic apparatus including a computer system. More specifically, the terminal apparatus 10 may be a personal computer, a mobile phone, a tablet, a smartphone, a PHS (Personal Handy-phone System) terminal apparatus, a game machine, or the like. The terminal apparatus 10 receives input from the user and presents information to the user.

The response control apparatus 30 is an electronic apparatus including a computer system. More specifically, the response control apparatus 30 is a server apparatus or the like. The response control apparatus 30 implements an agent and a filter (e.g., the system-user conversion filter lf)). In the present embodiment, for example, the agent and the filter are implemented by artificial intelligence. The artificial intelligence is a computer system that imitates human intellectual functions such as learning, reasoning, and judgment. The algorithm for realizing the artificial intelligence is not limited. More specifically, the artificial intelligence may be implemented by a neural network, case-based reasoning, or the like.

Here, an overview of a flow of processing by the information processing system 1 will be described.

The terminal apparatus 10 receives speech input from user. The terminal apparatus 10 transmits information indicating user's speech to the response control apparatus 30. The response control apparatus 30 receives information indicating user's speech from the terminal apparatus 10. The response control apparatus 30 refers to information indicating the user's speech and generates information indicating a response according to the user's speech. The response control apparatus 30 converts the information indicating the response by the filter, and generates information indicating the conversion result. The response control apparatus 30 transmits information indicating the conversion result to the terminal apparatus 10. The terminal apparatus 10 receives information indicating the conversion result from the response control apparatus 30. The terminal apparatus 10 refers to the information indicating the conversion result and presents the content of the converted response by display or voice.

Next, the configuration of the terminal apparatus 10 will be described.

FIG. 4 is a block diagram illustrating a configuration of the terminal apparatus 10.

The terminal apparatus 10 includes a communicator 11, an inputter 12, a display 13, an audio outputter 14, a storage 15, and a controller 16.

The communicator 11 transmits and receives various kinds of information to and from other apparatuses connected to the network NW such as the response control apparatus 30. The communicator 11 includes a communication IC (Integrated Circuit) or the like.

The inputter 12 receives input of various kinds of information. For example, inputter 12 receives input of speech from a user, selection of conversation scene, and the like. The inputter 12 may receive input from the user with any method such as character input, voice input, and pointing. The inputter 12 includes a keyboard, a mouse, a touch sensor and the like.

The display 13 displays various kinds of information such as contents of the user's speech, the contents of the responses of the agents, and the like. The display 13 displays various kinds of information. The display 13 includes a liquid crystal display panel, an organic EL (Electro-Luminescence) display panel, and the like.

The audio outputter 14 reproduces various sound sources. For example, the audio outputter 14 outputs the contents of the responses, and the like. The audio outputter 14 includes a speaker, a woofer, and the like.

The storage 15 stores various kinds of information. For example, the storage 15 stores a program executable by a CPU (Central Processing Unit) provided in the terminal apparatus 10, information referred to by the program, and the like. The storage 15 includes a ROM (Read Only Memory), a RAM (Random Access Memory), and the like.

The controller 16 controls various configurations of the terminal apparatus 10. For example, the controller 16 is implemented by the CPU of the terminal apparatus 10 executing the program stored in the storage 15. The controller 16 executes the conversation processor 161.

The conversation processor 161 controls the input and output processing for the conversation, for example. For example, the conversation processor 161 performs processing to provide the user interface for the conversation. For example, the conversation processor 161 controls transmission and reception of information indicating the user's speech and information indicating the conversion result of responses to and from the response control apparatus 30.

Next, the configuration of the response control apparatus 30 will be described.

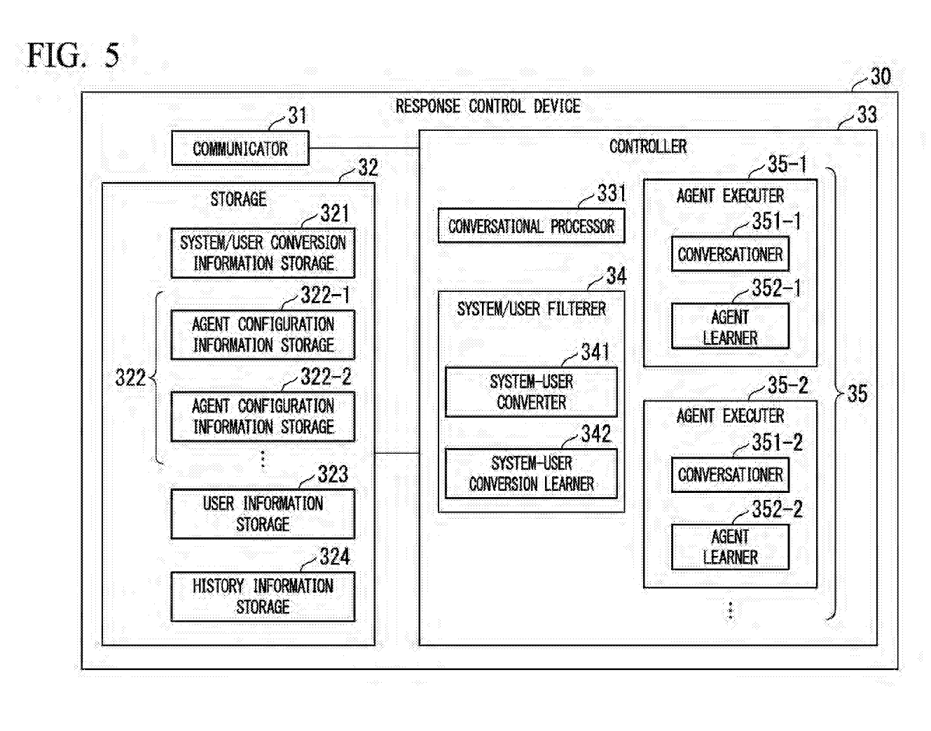

FIG. 5 is a block diagram illustrating a configuration of the response control apparatus 30.

The response control apparatus 30 includes a communicator 31, a storage 32, and a controller 33.

The communicator 31 transmits and receives various kinds of information to and from other apparatuses connected to the network NW such as the terminal apparatus 10. The communicator 31 includes ICs for communication and the like.

The storage 32 stores various kinds of information. For example, the storage 32 stores a program executable by the CPU provided by the response control apparatus 30, information referred to by the program, and the like.

The storage 32 includes a ROM, a RAM, and the like. The storage 32 includes a system-user conversion information storage 321, one or more agent configuration information storages 322-1, 322-2, . . . , a user information storage 323, and a history information storage 324. Hereinafter, the agent configuration information storage 322-1, 322-2, . . . will be collectively referred to as an agent configuration information storage 322, unless they are distinguished from each other.

The system-user conversion information storage 321 stores system-user conversion information. The system-user conversion information is information indicating the conversion rules by the system-user conversion filter lf. The system-user conversion information is an example of conversion information that indicates the conversion rule of speeches. In the present embodiment, for example, system-user conversion information is set for each user and stored for each user. For example, in a case where the system-user conversion filter lf is implemented by neural network, the system-user conversion information includes information such as parameters of activation functions that change according to machine learning as a result of machine learning. In a case where the system-user conversion filter lf is implemented by methods other than artificial intelligence, the system-user conversion filter lf may be, for example, information that uniquely associating responses and conversion results for the responses. This association may be made by a table and the like or may be made by a function and the like.

The agent configuration information storage 322 stores agent configuration information. The agent configuration information is information indicating the configuration of the agent executer 35. For example, in a case where the agent executer 35 is implemented by neural network, the agent configuration information includes information such as parameters of activation functions that change according to machine learning as a result of machine learning. The agent configuration information is an example of information that indicates the rule for generating a response in a conversation. In a case where the agent executer 35 is implemented by methods other than artificial intelligence, the agent configuration information may be, for example, information that uniquely associating responses and conversion results for the responses.

The user information is information indicating the attributes of a user. Hereinafter, an example of data configuration of user information will be explained.

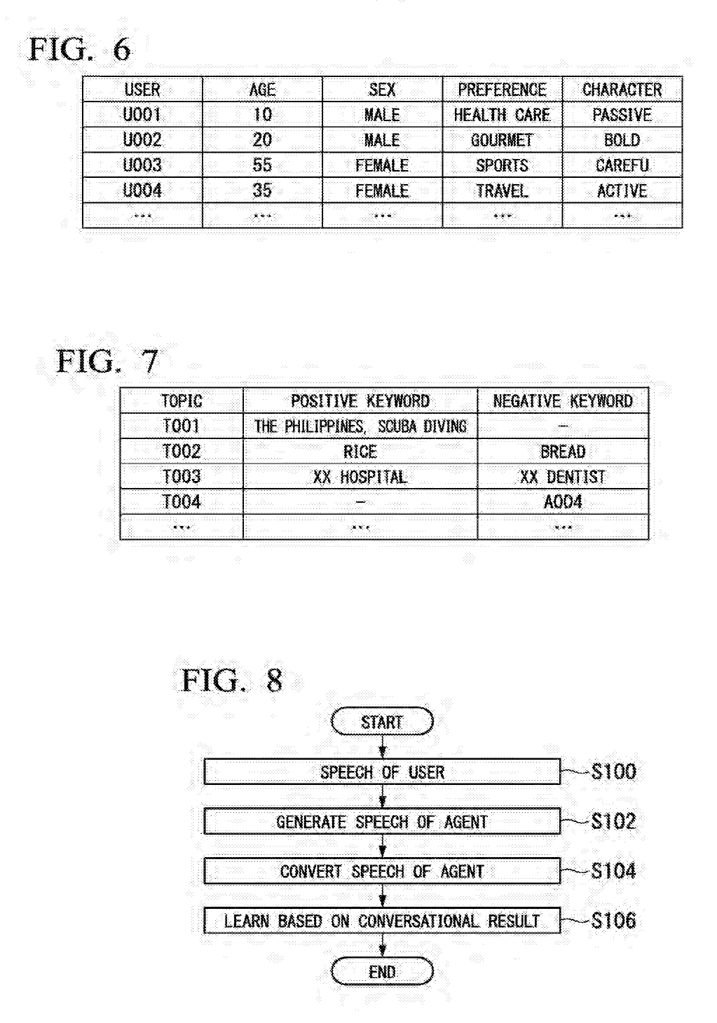

FIG. 6 illustrates the data configuration of the user information.

The user information is information obtained by associating, for example, user identification information (“user” in FIG. 6), age information (“age” in FIG. 6), sex information (“sex” in FIG. 6), preference information (“preference” in FIG. 6), and user character information (“character” in FIG. 6).

The user identification information is information for uniquely identifying the user. The age information is information indicating the age of the user. The sex information is information indicating the sex of the user. The preference information is information indicating the preference of the user. The user character information is information indicating the character of the user.

As described above, in the user information, the user and the individualities of the user are associated with each other. In other words, the user information indicates individualities of the user. Therefore, the terminal apparatus 10 and the response control apparatus 30 can confirm the individualities of the user by referring to the user information.

Referring back to FIG. 5, the explanation about the configuration of the response control apparatus 30 will be continued.

The history information storage 324 stores history information. The history information is information indicating the history of conversation between the user and the information processing system 1. The history information may be managed for each user. Here, an example of data configuration of history information will be described.

FIG. 7 illustrates the data configuration of history information.

The history information is information obtained by associating topic identification information (“topic” in FIG. 7), positive keyword information (“positive keyword” in FIG. 7), and negative keyword information (“negative keyword” in FIG. 7) with each other.

The topic identification information is information for uniquely identifying a conversation. The positive keyword information is information indicating a keyword for which the user shows a positive reaction in the conversation. The negative keyword information is information indicating a keyword for which the user shows a negative reaction in conversation. In history information, one or more pieces of positive keyword information and negative keyword information may be associated with a scene identification information.

Thus, the history information indicates the history of conversation. That is, by referring to the history information, the trend of the desired response for each user can be found from the history information. Therefore, by referring to the history information, the terminal apparatus 10 and the response control apparatus 30 can reduce making proposals that are difficult to be accepted by the user and can make proposals that can be easily accepted by the user.

Referring back to FIG. 5, the explanation about the configuration of the response control apparatus 30 will be continued.

The controller 33 controls various configurations of the response control apparatus 30. For example, the controller 33 is implemented by the CPU of the response control apparatus 30 executing the program stored in the storage 32. The controller 33 includes a conversation processor 331, a system-user filter unit 34, one or more agent executors 35-1, 35-2, . . . Hereinafter, the agent executers 35-1, 35-2, . . . are collectively referred to as the agent executer 35 unless they are distinguished from each other.

The conversation processor 331 controls input and output processing for conversation. The conversation processor 331 is a processor in the response control apparatus 30 according to the conversation processor 161 of the terminal apparatus 10. For example, the conversation processor 331 controls transmission and reception of information indicating the user's speech and information indicating the conversion result of responses to and from the terminal apparatus 10.

The conversation processor 331 manages history information. For example, when a positive word is included in a user's speech in the conversation, the conversation processor 331 identifies a keyword in user's speech or a keyword of response corresponding to the positive word, and registers the keyword in the positive keyword information.

For example, when a negative word is included in the user's speech, the conversation processor 331 identifies a keyword in user's speech or a keyword of response corresponding to the positive word, and registers the keyword in the negative keyword information. In this way, the conversation processor 331 may add, edit, and delete the history information according to the data configuration of the history information.

The system-user filterer 34 functions as a system-user conversion filter lf. In the present embodiment, for example, the system-user filterer 34 functions as a system-user conversion filter lf for each user. The system-user filterer 34 may perform processing by referring to information about the user such as the user information and the history information. The system-user filterer 34 includes a system-user conversationer 341 and a system-user conversion learner 342.

The system-user conversationer 341 converts the response generated by the agent executer 35 based on the system-user conversion information. The conversion of response may be performed by concealing, replacing, deriving, and changing the expression style and the like of the response content. Concealing the response content is to not present some or all of the response content. Replacing is to replace the response content with other wording. Deriving is to generate another speech derived from the response content. Changing the expression style is to change the sentence style, nuance, and the like of response without changing the substantial content of response. For example, changing the expression style includes changing the tone of the agent.

The system-user conversion learner 342 performs machine learning to realize the function of the system-user conversion filter lf. The system-user conversion learner 342 is capable of executing two types of machine learning: machine learning performed before the user starts usage: and machine learning by evaluation of the user in conversation. The result of machine learning by the system-user conversion learner 342 is reflected in the system-user conversion information. Hereinafter, “evaluation” is an indicator of the accuracy and appropriateness of response to the user. The training data used for machine learning by the system-user conversion learner 342 is data obtained by associating a response (for example, p2-1, p2-2, and the like illustrated in FIG. 2), a conversion result (for example, p3-1, p3-2, and the like illustrated in FIG. 2), and the evaluation. The training data may be associated with the user information and the history information. The evaluation may be a binary of true or false, or may be a value of three or more levels. By repeating machine learning using such training data, the system-user conversationer 341 can convert the response into a mode suitable for the user.

The system-user conversion learner 342 may perform different machine learning for each user by evaluating the user in conversation. That is, the system-user conversion information may be stored for each user. Hereinafter, for example, a case where machine learning is performed for each user will be described. In this case, the evaluation of the conversion result of response in reply to a certain speech of the user is reflected only in the system-user conversion information of the user in question. By performing such machine learning, the system-user conversationer 341 can convert the response of the agent into a preferable mode for each user.

Each of the agent executers 35-1, 35-2, . . . functions as a different agent (for example, agents a1, a2, . . . illustrated in FIG. 2). The agent executers 35-1, 35-2, . . . are realized based on the agent configuration information stored in the agent configuration information storages 322-1, 322-2, . . . The agent executors 35-1, 35-2, . . . include conversationers 351-1, 351-2, . . . , agent learners 352-1, 352-2, . . . Hereinafter, the conversationers 351-1, 352-1, . . . are collectively referred to as conversationers 351. Hereinafter, the agent learners 352-1, 352-2, . . . are collectively referred to as agent learner 352. In the present embodiment, for example, the agent, executor 35 is restricted from referring to information relating to user such as the user information and the history information.

The conversationer 351 generates a response of the agent in reply to user's speech.

The agent learner 352 performs machine learning to realize the function of the agent executer 35. The agent learner 352 is capable of executing two types of machine learning: machine learning performed before the user starts usage; and machine learning by evaluation of the user in conversation. The result of machine learning by the agent learner 352 is reflected in the agent configuration information.

The training data used for machine learning by the agent learner 352 is data obtained by associating user's speech (for example, p1 and the like illustrated in FIG. 2), a response (for example, p2-1, p2-2, and the like illustrated in FIG. 2), and the evaluation. Alternatively, the training data may be data obtained by associating a user's speech (for example, p1, and the like illustrated in FIG. 2), a conversion result of the response (for example, p3-1, p3-2, and the like illustrated in FIG. 2), and the evaluation. The agent learner 352 may use, as the training data, a response performed by another agent executer 35, which is not the agent executer 35 including the agent learner 352. By repeating learning using such training data, the conversationer 351 can generate a response according to user's speech.

The teacher data may be associated with user information and history information. In the present embodiment, for example, a case where the agent learner 352 performs machine learning by using training data that does not associate user information and history information will be explained. As a result, the conversationer 351 can generate responses purely dependent on speech content, not the user. In other words, the agent executer 35 can have a common general configuration among the users.

Next, the operation of the information processing system 1 will be described.

FIG. 8 is a flowchart illustrating a flow of processing by the information processing system 1.

(Step S100) The terminal apparatus 10 receives user's speech. Thereafter, the information processing system 1 advances the processing to step S102.

(Step S102) The response control apparatus 30 generates the response of each agent to the user's speech received in step S100 based on the agent configuration information. Thereafter, the information processing system 1 advances the processing to step S104.

(Step S104) The response control apparatus 30 converts the response generated in step S102 based on the user information, the history information, the system-user conversion information, and the like. The terminal apparatus 10 presents to the user the user's speech and the conversion result of the response generated according to the speech. Thereafter, the information processing system 1 advances the processing to step S106.

(Step S106) The response control apparatus 30 performs machine learning of the system-user conversion filter lf and the agent based on the conversation result. The conversation result is user's reaction to the presented conversion result and summary of the conversation, and indicates an evaluation for the system-user conversion filter lf and the agent. The conversation result may be given for the whole conversation or for each response. Thereafter, the information processing system 1 finishes the processing illustrated in FIG. 8.

The evaluation (conversation result) of the user for machine learning in step S106 may be specified from user's speech, or may be input by the user after the conversation. The evaluation may be entered as a binary of positive and negative, may be entered with three or more levels of values, or may be converted from a natural sentence into a value. The evaluation may be performed based on the characteristics of conversation. For example, the number of user's speeches in the conversation, the number of responses, the length of conversation, and the like indicate how active the conversation is. Therefore, the number of user's speeches in conversation, the number of responses, and the length of conversation may be used as an index of evaluation.

When a filter is evaluated, the evaluation target may be the system-user conversion filter lf of the user who performed the evaluation, or the system-user conversion filter lf of a user whose attribute is the same as the user who performed the evaluation. When an agent is evaluated, the evaluation target can be all the agents or some of the agents. For example, the evaluation for the entire conversation may be reflected in the system-user conversion filter lf of the user who performed the evaluation, the system-user conversion filter lf of a user whose attribute is the same as the user, all the agents who participated in the conversation, and the like. The evaluation for the response man be reflected in the system-user conversion filter lf of the user who performed the evaluation, the system-user conversion filter lf of a user whose attribute is be same as the user, or may be reflected in only the agent that made the response.

Next, a presentation mode of a response in conversation will be explained.

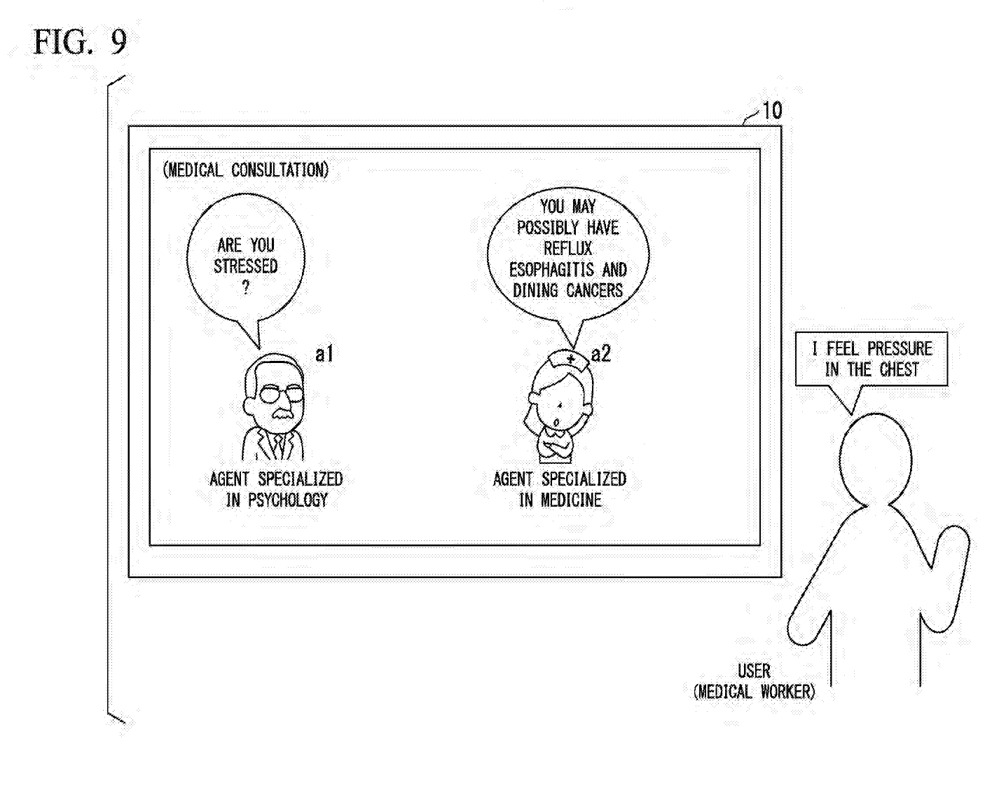

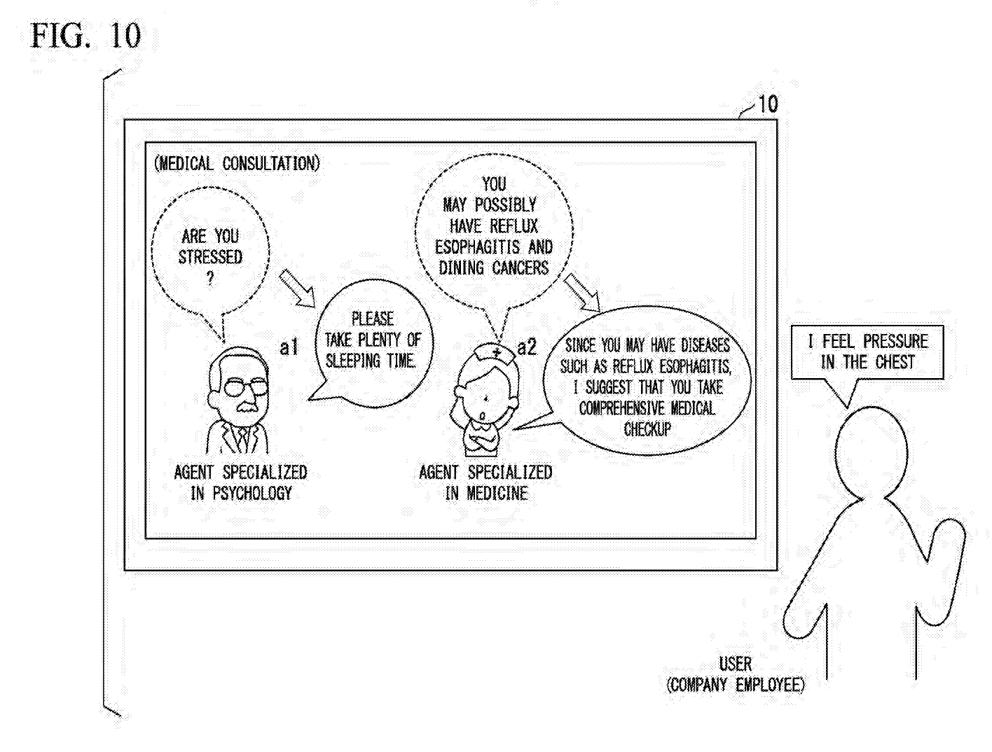

FIG. 9 and FIG. 10 is a diagram illustrating a presentation example of a response by the information processing system 1.

In the examples illustrated in FIG. 9 and FIG. 10, medical consultation for “I feel pressure in the chest” is performed by the user. However, in the example illustrated in FIG. 9, the user is a medical worker, while in the example illustrated in FIG. 10, the user is a company employee. Providing accurate medical information to medical personnel is required. Therefore, in the example illustrated in FIG. 9, the filter presents the responses of the agents a1 and a2 as they are without conversion.

On the other hand, it is not always the best way to provide medical information accurately to the company employee. For example, there are cases where it is undesirable to notice unnecessary notice when the user dislikes that the presence or absence of stress is pointed out or the possibility of having a serious disease unnecessarily. Therefore, in the example illustrated in FIG. 10, the filter converts the response by the agent a1 pointing out the presence or absence of stress into a response that presents a stress relaxation method. The filter converts a response by the agent a2 pointing out the possibility of a caused disease into a response that presents a part of the name of the disease and a countermeasure for the disease.

As described above, the information processing system 1 (an example of an information processing system) includes a conversationer 351 (an example of a conversationer), a storage 32 (an example of a storage), a system-user filterer 34 (an example of a system-user conversationer). The conversationer 351 generates a response (an example of speech) and performs conversation with the user. The storage 32 stores system-user conversion information (an example of conversion information) indicating the conversion rule of speech. The system-user filterer 34 converts the speech generated by the conversationer 351 into a mode according to the user by using the system-user conversion information stored in the storage 32.

As a result, the response generated by the conversationer 351 is converted into a mode according to the user by the system-user filterer 34. For example, even when the response generated by the conversationer 351 includes content that causes discomfort to the user or information of which presentation to the user is not desirable, the response is converted to reduce discomfort or suppress presentation of information. For example, the response generated by the conversationer 351 is converted into a polite expression or the response into an itemized expression, so as to make it easier for the user to accept or to confirm the response. Therefore, the information processing system 1 can make a response according to the user. In the information processing system 1, the generation of the response and the conversion of the response are configured to be separate processing. Therefore, in the generation of the response, generality is ensured by not depending on the user, but in the conversion of the response, diversity is ensured by depending on the user. In other words, the information processing system 1 can achieve both versatility and diversity.

In information processing system 1, the storage 32 stores the system-user conversion information for each user. The system-user filterer 34 converts the speech generated by the conversationer 351 into a mode according to the user by using the system-user conversion information (an example of conversion information) for each user stored in the storage 32.

As a result, the response generated by the conversationer 351 is converted into a mode according to the user by using the system-user conversion information for each user. In other words, the conversion of the response is performed by conversion rule dedicated to each user. For this reason, the information processing system 1 can perform conversions for individual users whose individualities are different. Therefore, the information processing system 1 can make a response according to the user.

### Second Embodiment

The second embodiment will be explained. In the present embodiment, constituent elements similar to those described above are denoted by the same reference numerals, and explanations thereabout incorporated herein by reference.

The information processing system 1A (not illustrated) according to the second embodiment is a system which presents conversion a response upon converting the response with the agent to a manner similar to the information processing system 1. However, the information processing system 1A is different in that the information processing system 1A converts user's speeches.

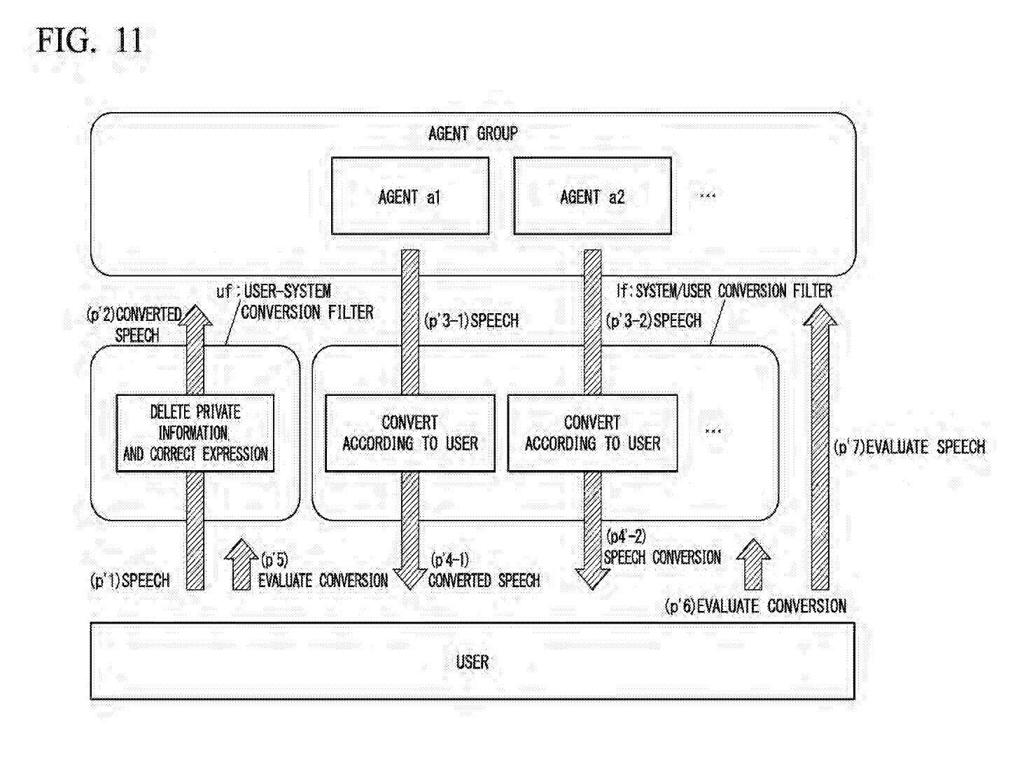

Here, with reference to FIG. 11, a flow of conversation and an overview of conversion with the filter will be described.

FIG. 11 is a diagram illustrating an overview of the filter according to the present embodiment.

In conversation of the present embodiment, first, the user makes speech such as a question (p′1). Next, the user-system conversion filter uf converts user's speech and outputs the user's speech to each agents a1, a2, . . . (p′2). The user-system conversion filter uf may be provided for each user, or may be commonly used by users. Here, for example, a case where the user-system conversion filter uf is commonly used by users will be explained. Next, the agents a1, a2, . . . generate responses to user's speech (p′3-1, p′3-2, . . . ), respectively. In this conversion, for example, deletion of personal information and modification of expression are performed.

Next, the system-user conversion filter lf converts the responses of agents a1, a2, . . . according to the users and presents the converted responses to the user (p′4-1, p′4-2, . . . ). Next, the user evaluates the responses of the agents a1, a2, . . . This evaluation is reflected in conversion processing by the user-system conversion filter uf, conversion processing by the system-user conversion filter lf, generation processing of responses by the agents a1, a2, . . . (p′5, p′6, p′7). In this way, the information processing system 1A does not output user's speeches as they are to the agents a1, a2, . . . but converts user's speeches before outputting the user's speeches. Therefore, for example, the information processing system 1A can prevent the personal information about the user from being learned to the agents a1, a2, . . . and being used for responses to other users, and the information processing system 1A can accurately understand the intention of the user's speech to improve the accuracy of the responses.

Next, the configuration of the information processing system 1A will be described.

The information processing system 1 A includes a response control apparatus 30A instead of the response control apparatus 30 included in the information processing system 1.

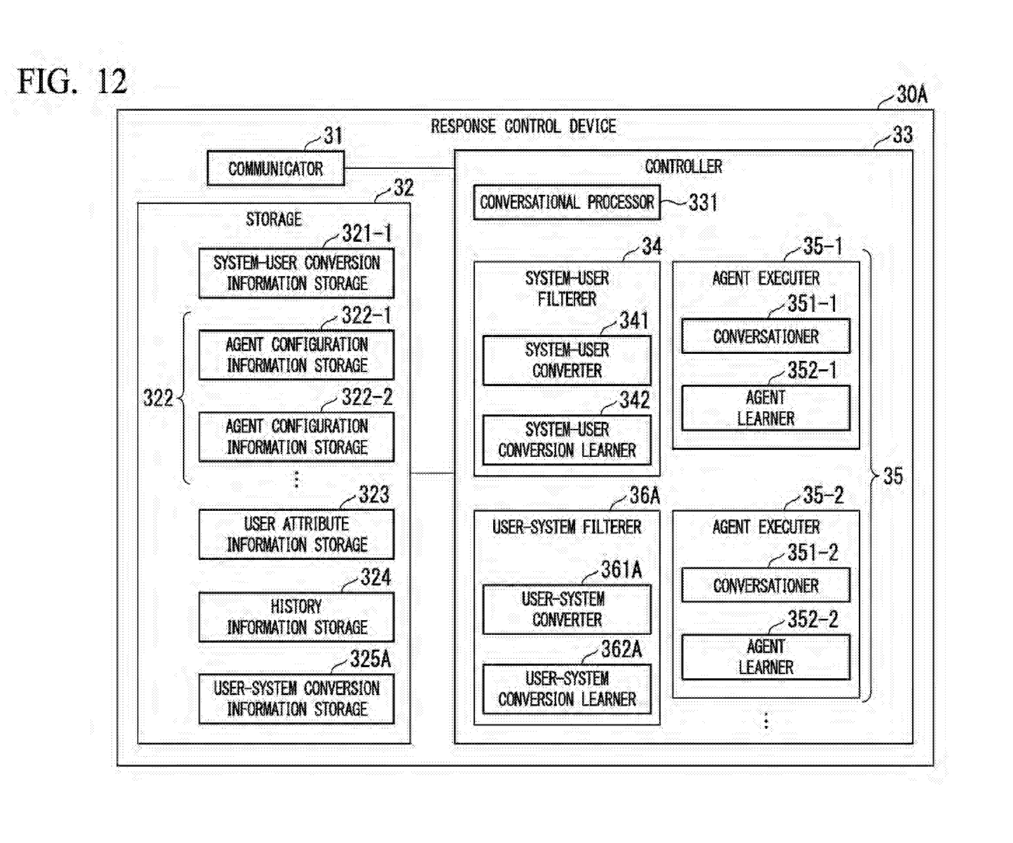

FIG. 12 is a block diagram illustrating a configuration of the response control apparatus 30A.

The storage 32 of the response control apparatus 30A has a user-system conversion information storage 325A. The controller 33 of the response control apparatus 30A has a user-system filterer 36A.

The user-system conversion information storage 325A stores user-system conversion information. The user-system conversion information is information indicating the conversion rules by the user-system conversion filter uf. The user-system conversion information is an example of conversion information that indicates the conversion rule of speeches. For example, in a case where the user-system conversion filter uf implemented by neural network, the user-system conversion information includes information such as parameters of activation functions that change according to machine learning as a result of machine learning. In a case where the user-system conversion filter uf is implemented by methods other than artificial intelligence, the user-system conversion filter uf may be, for example, information that uniquely associating speeches and conversion results for the speeches. This association may be made by a table and the like or may be made by a function and the like.

The user-system filterer 36A functions as the user-system conversion filter uf. The user-system filterer 36A includes a user-system conversationer 361A and a user-system conversion learner 362A.

The user-system conversationer 361A converts user's speech based on the user-system conversion information. The conversion of user's speech may be performed by concealing, replacing, deriving, and changing the expression style and the like of the speech content. Concealing the speech content is to not present some or all of the speech content. Replacing is to replace the speech content with other wording. Deriving is to generate another speech derived from the speech content. Changing the expression style is to change the sentence style, nuance, and the like of speech without changing the substantial content of speech. For example, changing the expression style includes performing morpheme analysis of the wordings constituting speech and showing the result of the morpheme analysis, shortening the speech content, and the like. In other words, the habit of user's wording and the like may be eliminated.

The user-system conversion learner 362 performs machine learning to realize the function of the user-system conversion filter uf. The user-system conversion learner 362 is capable of executing two types of machine learning: machine learning performed before the user starts usage; and machine learning by evaluation of the user in conversation. The result of machine learning by the user-system conversion learner 362 is reflected in the user-system conversion information. The training data used for machine learning by the user-system conversion learner 362 may be data obtained by associating a user's speech (for example, p′1 illustrated in FIG. 11), a conversion result (for example, p′2 illustrated in FIG. 11), and the evaluation. The evaluation may be a binary of true or false, or may be a value of three or more levels. By repeating machine learning using such training data, the user-system conversationer 361A can convert the user's speech.

Next, the operation of the information processing system 1A will be described.

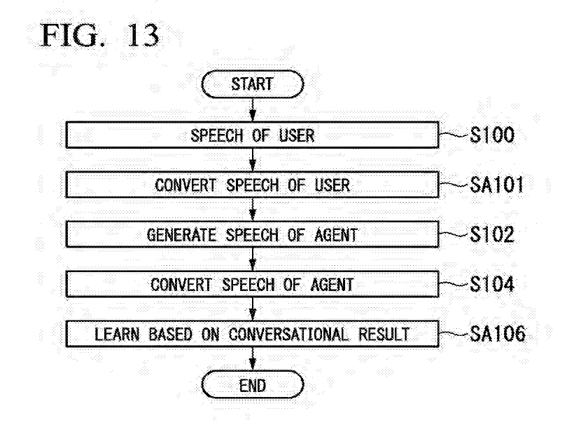

FIG. 13 is a flowchart illustrating a flow of processing by the information processing system 1A.

Steps S100, S102, S104 illustrated in FIG. 13 are similar to steps S100, S102, S104 illustrated in FIG. 8, and explanations thereabout incorporated herein by reference.

(Step SA101) After step S100, the response control apparatus 30A converts the user's speech received in step S100 based on user information, history information, user-system conversion information, and the like. Thereafter, the information processing system 1A advances the processing to step S102.

(Step SA106) After step S104, the response control apparatus 30A performs machine learning of the user-system conversion filter uf, the system-user conversion filter lf, and the agent on the basis of the conversation result. The conversation result is user's reaction to the presented conversion result, and indicates an evaluation for the user-system conversion filter uf, the system-user conversion filter lf, and the agent evaluation. Thereafter, the information processing system 1A terminates the processing illustrated in FIG. 13.

The user-system conversion filter uf may control learning by the system-user conversion filter lf and the agent. For example, the user-system conversion filter uf may selects (determines) a system-user conversion filter lf and an agent that performs machine learning and notify the evaluation of the user (conversation result) only to the system-user conversion filter lf and agent that performs the machine learning. On the other hand, the user-system conversion filter uf does not notify the evaluation of the user to a system-user conversion filter lf and an agent which do not perform machine learning.

For example, only the system-user conversion filter lf may be caused to perform learning for an evaluation performed due to conversion, e.g., when a response of the user is related to a response content deleted by system-user conversion filter lf. On the other hand, only the agent may be caused to perform learning for an evaluation performed not due to conversion, e.g., when a response of the user is related to a response content that does not change before and after the conversion by system-user conversion filter lf.

For example, an agent that performs learning may be selected according to the relationship between the user and the agent, the attribute of the agent, and the like. When selection is made according to the relationship between the user and the agent, for example, a history of the evaluation of each agent by the user is managed. Accordingly, learning may be caused to be performed only for an agent that has acquired a higher evaluation, i.e., an agent that has good relationship with the user. When selection is made the attribute of the agent, for example, an agent that has the same attribute as the agent that has performed a response evaluated by the user may be caused to perform learning.

The attribute of agent may be managed by presetting information indicating attribute for each agent. For example, categories, characters, and the like may be set as the attribute of agent. A category is a classification of an agent, for example, a field specialized in conversation by the agent. A character is tendency of response such as aggressiveness and emotional expression. The control of learning of the system-user conversion filter lf and the agent may be performed by a configuration different from the user-system conversion filter uf, such as the conversation processor 331, for example.

As described above, the information processing system 1A (an example of an information processing system) includes a conversation processor 331 (an example of a receiver), and a user-system filterer 36A (an example of a user-system conversationer). The conversation processor 331 accepts speech from user. The user-system filterer 36A converts the speech received by the conversation processor 331 into a mode according to the conversationer 351.

As a result, user's speech is converted into a mode according to the conversationer 351. For example, if individual information is included in user's speech, individual information is deleted. For example, when the expression of user's speech is inappropriate for processing by the conversationer 351, it is converted to mode suitable for processing by the conversationer 351. Therefore, the information processing system 1 can protect individual information and generate an appropriate response.

The information processing system 1A (an example of an information processing system) includes a system-user filterer 34 (an example of a system-user conversationer) and a user-system filterer 36A (an example of a first determiner). The system-user filterer 34 performs conversion based on machine learning. The user-system filterer 36A determines whether or not to perform the machine learning.

As a result, the system-user filterer 34 performs only necessary machine learning. Therefore, the information processing system 1A can improve the accuracy of conversion.

The information processing system 1 A (an example of an information processing system) includes a plurality of agent executers 35 (an example of a conversationer) and a user-system filterer 36A (an example of a second determiner). The agent executer 35 generates speech based on machine learning. The user-system filterer 36A selects an agent executer 35 that performs machine learning out of the plurality of agent executers 35.

In other words, the information processing system 1A narrows down the agent executers 35 that performs machine learning.

On the other hand, when a plurality of agent executers 35 perform the same machine learning, there is a possibility that the responses of the agent executers 35 are homogenized. In this regard, since the information processing system 1A selects the target of machine learning, the individualities of the individual agent executers 35 can be maintained, so that the information processing system 1A can achieve both of the versatility and diversity of responses. The information processing system 1A, for example, can improve the accuracy of the responses to the users whose individualities are similar by setting the target of machine learning to an agent having a good relationship with the user.

### Third Embodiment

The third embodiment will be explained. In the present embodiment, constituent elements similar to those described above are denoted by the same reference numerals, and explanations thereabout incorporated herein by reference

An information processing system 1B (not illustrated) according to the third embodiment is a system which presents conversion by converting a response of an agent in a manner similar to the information processing system 1. However, the information processing system 1B is different in that the information processing system 1B has multiple system-user conversion filters.

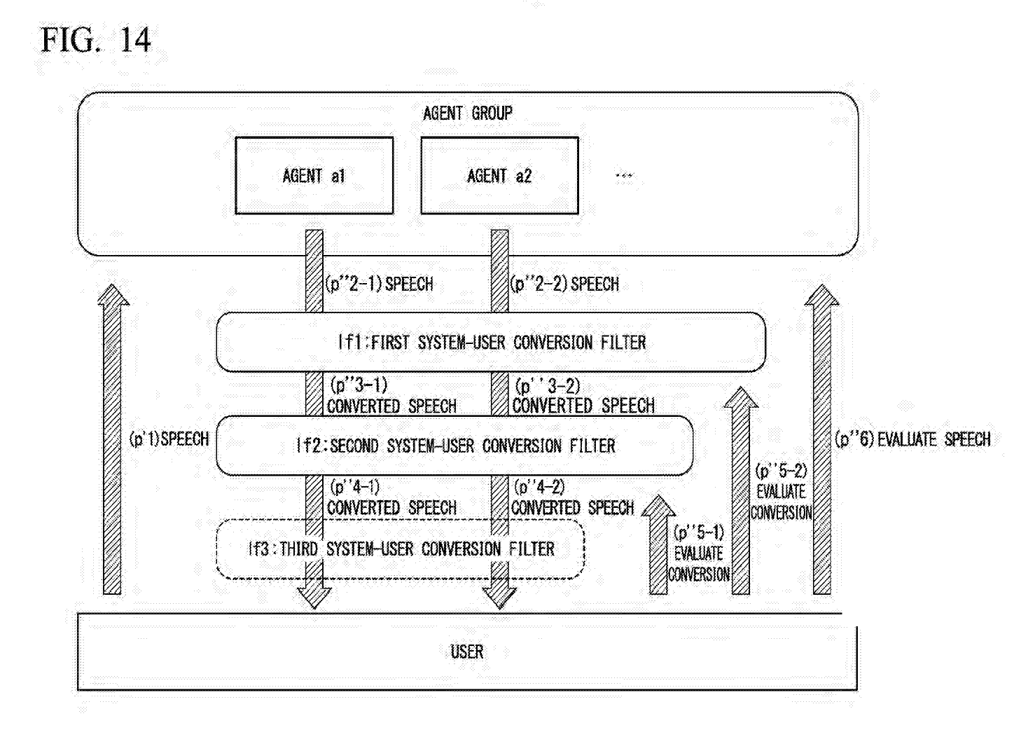

Here, with reference to FIG. 14, an overview of conversation flow and conversion by filter will be described.

FIG. 14 is a diagram illustrating an overview of a filter according to the present embodiment.

Here, for example, a case where three system-user conversion filters lf1, lf2, lf3 are provided will be described. Hereinafter, when the system-user conversion filters lf1, lf2, lf3 are not distinguished from each other, the system-user conversion filters lf1, lf2, lf3 will be collectively referred to as system-user conversion filter lf.

In the conversation according to the present embodiment, first, the user makes speech such as a question (p″1). Next, the agents a1, a2, . . . generate responses (p″2-1, p″2-2, . . . ) in reply to user's speeches. Next, the first system-user conversion filter lf1 converts the responses of the agents a1, a2, . . . according to the user, and presents the converted responses to the user (p″3-1, p″3-2, . . . ). Next, the second system-user conversion filter lf2 converts the conversion result of the second system-user conversion filter lf1 according to the user and presents the conversion result to the user (p″4-1, p″4-2, . . . ). In this example, the information processing system 1B has the third system-user conversion filter lf3 but does not apply the third system-user conversion filter lf3 and does not perform the conversion by the third system-user conversion filter lf3.

Next, the user evaluates the responses of agents a1, a2, . . . This evaluation is reflected in the conversion processing by the applied system-user conversion filter lf1, lf2 and the generation processing of response by the agents a1, a2, . . . (p″5-1, p″5-2, p″6). In this way, the information processing system 1B can convert the responses of the agents a1, a2, . . . by using multiple system-user conversion filters. Further, the information processing system 1B can select the applicable system-user conversion filter. Therefore, for example, by switching the system-user conversion filter applied for each user, a desirable response according to user can be presented.

Next, the configuration of the information processing system 1B will be described.

The information processing system 1B includes a response control apparatus 30B instead of the response control apparatus 30 of the information processing system 1.

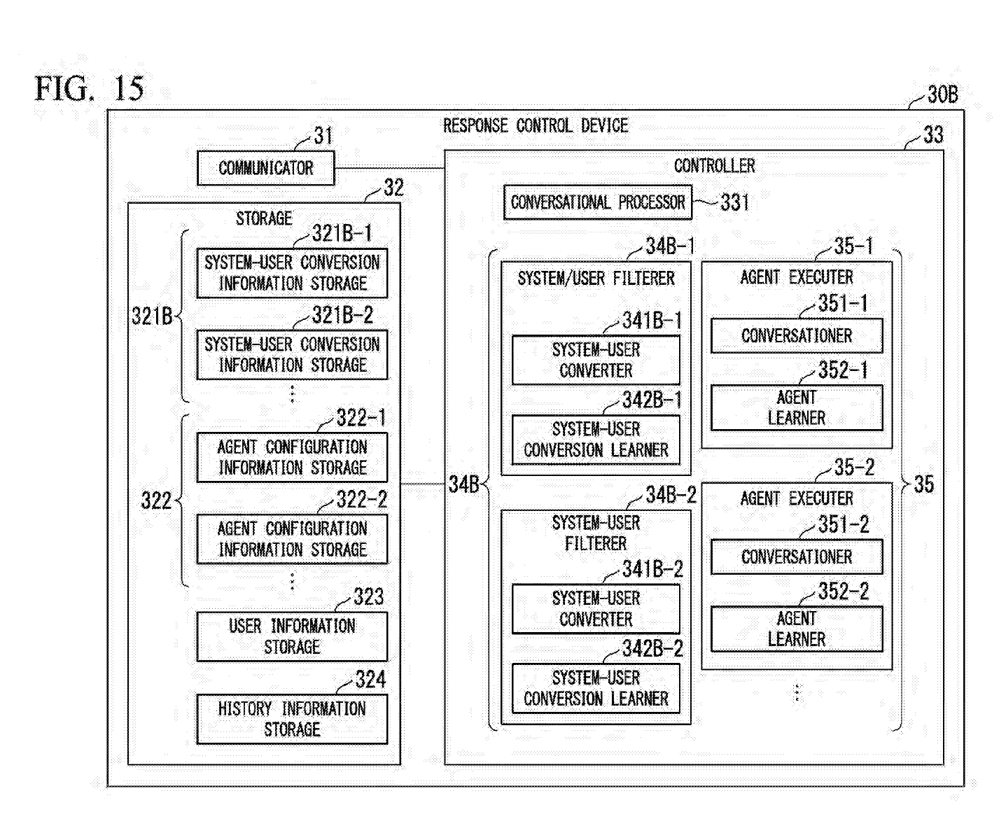

FIG. 15 is a block diagram illustrating a configuration of the response control apparatus 30B.

The storage 32 of the response control apparatus 30B includes system-user conversion information storages 321B-1, 321B-2, . . . instead of the system-user conversion information storage 321. Hereinafter, the system-user conversion information storages 321-1, 321-2, . . . will be collectively referred to as system-user conversion information storage 321B. The controller 33 of the response control apparatus 30B has a conversationer 351B instead of the conversationer 351. The controller 33 of the response control apparatus 30B has system-user filters 34B-1, 34B-2, . . . instead of the system-user filterer 34. Hereinafter, the system-user filterers 34B-1, 34B-2, . . . are collectively referred to as system-user filterer 34B.

The system-user conversion information storage 321B stores system-user conversion information.

However, the system-user conversion information according to the present embodiment differs in that the system-user conversion information is information for each attribute of user, not for each user.

Like the conversation processor 331, the conversation processor 331B controls input and output processing for conversation. The conversation processor 331B selects the system-user conversion filter lf to be applied according to user. For example, the conversation processor 331B refers to the user information of the user who conserves, and confirms the attribute of the user. Then, the conversation processor 331B searches the system-user conversion information using the attribute of the user who converses, and selects the system-user conversion filter lf matching the attribute of the user who converses. Specifically, when the user is a male, the conversation processor 331B selects a system-user conversion filter lf for men, and when the user is an elementary school student, the conversation processor 331B selects a system-user conversion filter lf for youth.

Like the system-user filterer 34, the system-user filterer 34B functions as a system-user conversion filter lf. However, the system-user filterer 34B functions as a system-user conversion filter lf for each attribute of user, not as a system-user conversion filter lf for each user.

Next, an operation of the information processing system 1B will be described.

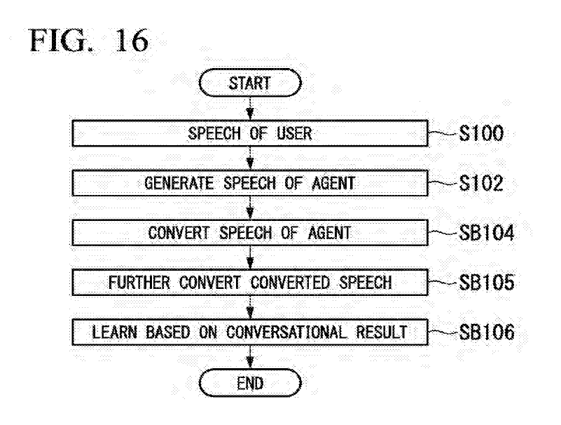

FIG. 16 is a flowchart illustrating a flow of processing by the information processing system 1B.

Here, for example, a case will be explained in which two system-user conversion filters lf are selected as applicable targets for conversation with user. Steps S100 and S102 illustrated in FIG. 16 are the same as steps S100 and S102 illustrated in FIG. 8, so the explanation will be cited, and explanations thereabout incorporated herein by reference.

(Step SB104) After the processing of step S102, the response control apparatus 30B converts the response generated in step S102 on the basis of the user information, the history information, and the system-user conversion information of the first system-user conversion filter lf1. Thereafter, the information processing system 1B advances the processing to step SB105.

(Step SB105) The response control apparatus 30B converts the response generated in step SB104 on the basis of the user information, the history information, and the system-user conversion information of the second system-user conversion filter lf2. Thereafter, the information processing system 1B advances processing to step SB106.

(Step SB106) The response control apparatus 30B performs machine learning of the two applied system-user conversion filter lf and the agent on the basis of the conversation result. The conversation result is user's reaction to the presented conversion result, and indicates the evaluation for the applied system-user conversion filter lf and the agent. Thereafter, the information processing system 1B finishes the processing illustrated in FIG. 16.

A described above, in the information processing system 1B (an example, of an information processing system), the storage 32 (an example of a storage) stores the system-user conversion information (an example of conversion information) for each attribute of the user. The system-user filterer 34 searches the system-user conversion information stored in the storage 32 by using the attribute of the user, and uses the conversion information identified by the search, and converts the speech generated by the conversationer 351 into a mode according to the user.

Accordingly, the response generated by the conversational 351 is converted into a mode according to the user based on the attribute of the user. In other words, conversion of response according to individual user is performed using a general conversion rule for each user attribute. Therefore, the information processing system 1B is easier to perform conversion according to the user with less load than a case where a dedicated conversion rule is set for each user. Therefore, the information processing system 1 can make a response according to the user.

### Fourth Embodiment

The fourth embodiment will be explained. In the present embodiment, constituent elements similar to those described above are denoted by the same reference numerals, and explanations thereabout incorporated herein by reference.

An information processing system 1C (not illustrated) according to the fourth embodiment is a system which presents conversion by converting responses by agents in a manner similar to the information processing system 1. In the information processing system 1, however, the response control apparatus 30 is given the filter function, whereas in the information processing system 1C, the function of the filter is provided in a terminal apparatus of a user.

The configuration of information processing system 1C will be explained.

The information processing system 1C includes a terminal apparatus 10C and a response control apparatus 30C instead of the terminal apparatus 10 and the response control apparatus 30 of the information processing system 1.

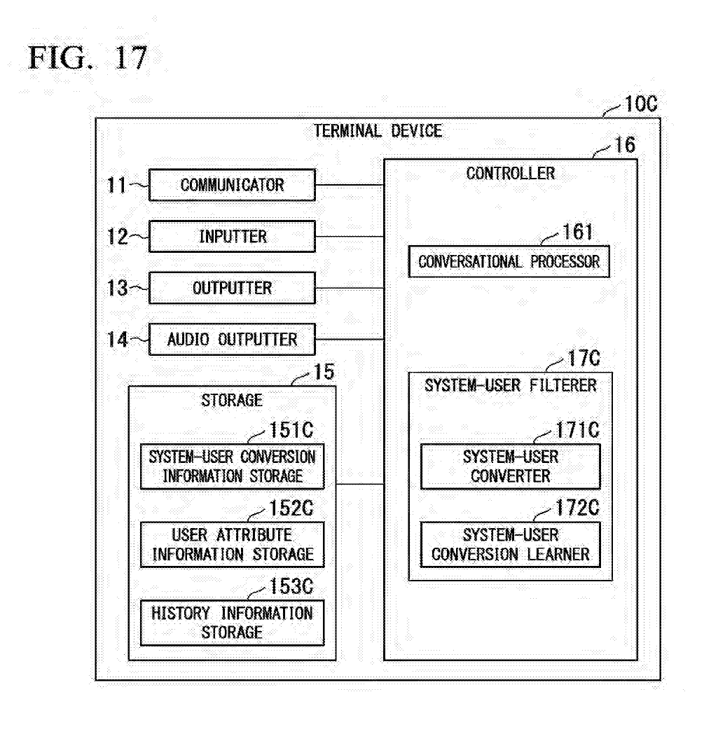

FIG. 17 is a block diagram illustrating the configuration of the terminal apparatus 10C.

The storage 15 of the terminal apparatus 10C includes a system-user conversion information storage 151C, a user information storage 152C, and a history information storage 153C. The controller 16 of the terminal apparatus 10C has a system-user filterer 17C. The system-user filterer 17C includes a system-user conversationer 171C and a system-user conversion learner 172 C.

The system-user conversion information storage 151C has the same configuration as the system-user conversion information storage 321. The user information storage 152C has the same configuration as the user information storage 323. The history information storage 153C has the same configuration as the history information storage 324.

The system-user filterer 17C has the same configuration as the system-user filterer 34. The system-user conversationer 171C has the same configuration as the system-user conversationer 341. The system-user conversion learner 172 C has the same configuration as the system-user conversion learner 342.

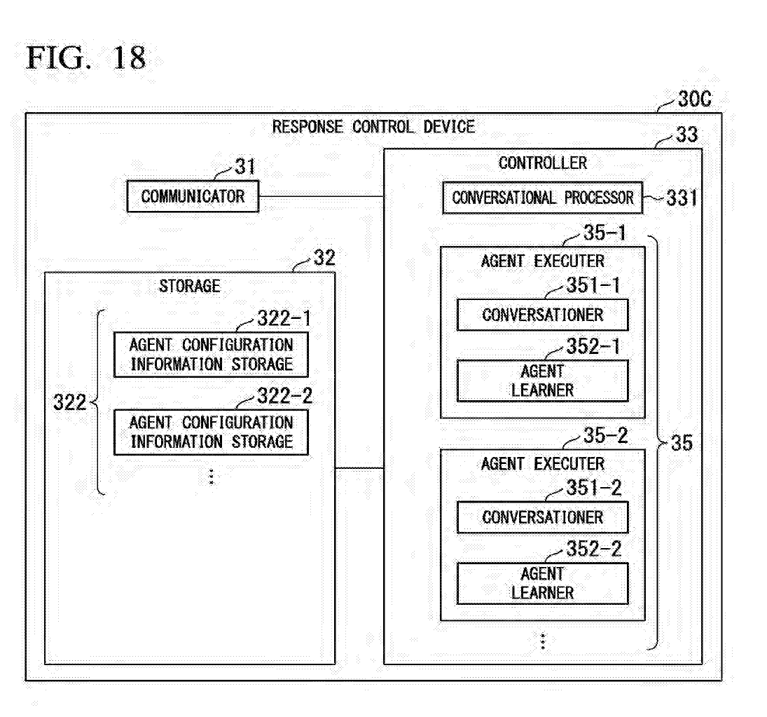

FIG. 18 is a block diagram illustrating a configuration of the response control apparatus 30C.

The storage 32 of the response control apparatus 30C does not have the system-user conversion information storage 321 of the storage 32 of the response control apparatus 30. The controller 33 of the response control apparatus 30C has does not have the systems-user filterer 34.

As described above, in the information processing system 1C (an example of the information processing system), the terminal apparatus 10C has the system-user filterer 17C. In this way, any configuration in the aforementioned embodiments may be separately provided in separate apparatuses or may be combined into a single apparatus.

In each of the above embodiments, the system-user conversion filter lf is described as indicating a conversion rule according to user, but the embodiment is not limited thereto. The system-user conversion filter lf may indicate a conversion rule according to the agent, or may indicate a conversion rule according to a combination of the user and the agent. That is, conversion rules according to the relationship between the user and the agent may be indicated.

In the above embodiment, the data configuration of various kinds of information are not limited to those described above.

The association of pieces of information may be made directly or indirectly. Information not essential for processing may be omitted, or processing may be performed by adding similar information. For example, as user information, the user's residence or occupation may be included. For example, the history information may not be the aggregate of the contents of the conversations as in the above embodiment, but may be the information in which the conversation itself is recorded.

In the above embodiment, the presentation modes of responses are not limited to those described above. For example, each speech may be presented in chronological order. For example, response may be presented without clarifying the response agent that made the response.

In the above embodiment, the agent executer 35 is restricted from referring to the information about the user such as the user information and the history information, but the present invention is not limited thereto. For example, the agent executer 35 may generate a response and perform machine learning by referring to information about the user. However, individual information can be protected by restricting the agent executer 35 from referring to information about the user.

For example, when the agent executer 35 is used for responses to a plurality of users, the result of machine learning to other users is reflected in responses to a certain user. If this machine learning includes individual information about other users, individual information may be included in the generated response, and the individual information about the user may be leaked. In this regard, by restricting the reference to the user information, individual information will not be included in responses. In this manner, the use of arbitrary information described in the embodiment may be limited by designation from the user or in the initial setting.

In each of the above embodiments, the controller 16 and the controller 33 are software function units, but the controller 16 and the controller 33 may be hardware function units such as LSI (Large Scale Integration) or the like.

According to at least one embodiment described above, with the system-user filterer 34, a response to user's speech can be made according to the user.

The processing of the terminal apparatus 10, 10C, the response control apparatuses 30, 30A to 30C may be performed by recording a program for realizing the functions of the terminal apparatuses 10, 10C, the response control apparatuses 30 and 30A to 30C described above in a computer readable recording medium and causing a computer system to read and execute the program recorded in the recording medium. Here, “loading and executing the program recorded in the recording medium by the computer system” includes installing the program in the computer system. The “computer system” referred to herein includes an OS and hardware such as peripheral devices.

The “computer system” may include a plurality of computer apparatuses connected via a network including a communication line such as the Internet, a WAN, a LAN, a dedicated line, or the like.

“Computer-readable recording medium” refers to a storage device such as a portable medium such as a flexible disk, a magneto-optical disk, a ROM, a CD-ROM, or a hard disk built in a computer system. The recording medium storing the program may be a non-transitory recording medium such as a CD-ROM. The recording medium also includes a recording medium provided internally or externally accessible from a distribution server for distributing the program. The code of the program stored in the recording medium of the distribution server may be different from the code of the program in a format executable by the terminal apparatus. That is, as long as it can be installed in a downloadable form from the distribution server and executable by the terminal apparatus, the format stored in the distribution server can be any format. The program may be divided into a plurality of parts, which may be downloaded at different timings and combined by the terminal apparatus, and a plurality of different distribution servers may distribute the divided parts of the program. Further, the “computer readable recording medium” holds a program for a certain period of time, such as a volatile memory (RAM) inside a computer system serving as a server or a client when a program is transmitted via a network. The above program may realize only some of the above-described functions. Furthermore, the program may be a so-called differential file (differential program) which can realize the above-described functions in combination with a program already recorded in the computer system.

Some or all of the functions of the above-described terminal apparatuses 10, 10C, response control apparatuses 30, 30A to 30C may be realized as an integrated circuit such as an LSI. Each of the above-described functions may be individually implemented as a processor, or some or all of the functions thereof may be integrated into a processor. The method of integration is not limited to LSI, and may be realized by a dedicated circuit or a general purpose processor.

When an integrated circuit, technology to replace LSI appears due to advances in semiconductor technology, an integrated circuit based on such technology may be used.

While several embodiments of the invention have been described, these embodiments are presented by way of example and are not intended to limit the scope of the invention. These embodiments can be implemented in various other forms, and various omissions, substitutions, and changes can be made without departing from the gist of the invention. These embodiments and variations thereof are included in the scope and the gist of the invention, and are also included within the invention described in the claims and the scope equivalent thereto.

1. An information processing system comprising:
a conversationer performing conversation with a user by generating a speech;
a storage storing conversation information indicating a conversation rule of the speech; and
a system-user conversationer converting the speech generated by the conversationer into a mode according to the user by using the conversion information stored in the storage.

2. The information processing system according to claim 1, further comprising:
a receiver receiving the speech from the user;
a user-system conversationer converting the speech received by the receiver into a mode according to the conversationer.

3. The information processing system according to claim 1, wherein the system-user conversationer converts the speech generated by the conversationer into a mode according to the user by using conversion information for each user stored in the storage.

4. The information processing system according to claim 1, wherein the system-user conversationer searches conversion information for each attribute of the user stored in the storage by using an attribute of the user, and converts the speech generated by the conversationer into a mode according to the user by using the conversion information obtained through the search.

5. The information processing system according to claim 1, wherein the system-user conversationer performs conversion based on machine learning,
the information processing system further compresses a first determiner determining whether the machine learning is to be performed.

6. The information processing system according to claim 1, wherein the conversationer generates a speech based on machine learning,
the information processing system further comprising a second determiner determining a conversationer performing the machine learning from among the plurality of conversationers.

7. An information processing apparatus comprising:
a conversationer performing conversation with a user by generating a speech; and
a system-user conversationer reading conversation information indicating a conversation rule of the speech, and converting the speech generated by the conversationer into a mode according to the user by using the read conversion information.

8. An information processing method performed by an information processing system including an a storage storing conversation information indicating a conversation rule of a speech
the information processing method comprising:
a first step causing the information processing system to perform conversation with a user by generating a speech;
a second step causing the information processing system to convert the speech generated in the first step into a mode according to the user by using the conversion information stored in the storage.

9. A recording medium storing a program for causing a computer to execute:
a first step causing the information processing system to perform conversation with a user by generating a speech;
a second step causing the information processing system to read conversation information indicating a conversation rule of the speech, and convert the speech generated in the first
step into a mode according to the user by using the conversion information.
